(19) United States
(12) Patent Application Publication
(10) Pub. No.: US 2025/0373369 A1
(43) Pub. Date: Dec. 4, 2025

(54) Link Adaptation with Fast Feedback

(71) Applicant: Apple Inc., Cupertino, CA (US)

(72) Inventors: Tianyu Wu, Fremont, CA (US); Jinjing Jiang, San Jose, CA (US); Kanke Wu, San Jose, CA (US); Yong Liu, Campbell, CA (US); Wook Bong Lee, San Jose, CA (US); Anuj Batra, Redwood City, CA (US); Yan Zhang, Palo Alto, CA (US); Jarkko L. Kneckt, Los Gatos, CA (US)

(21) Appl. No.: 19/184,834

(22) Filed: Apr. 21, 2025

Related U.S. Application Data
(60) Provisional application No. 63/641,193, filed on May 1, 2024.

(51) Int. Cl. H04L 1/1607

(52) U.S. Cl. CPC H04L 1/1671

(57) ABSTRACT

This disclosure relates to methods for link adaptation with fast feedback in a wireless local area network. A wireless device can receive a physical protocol data unit (PPDU), e.g., from another wireless device such as from an access point. The wireless device can transmit a block acknowledgment (BA) frame that includes fast feedback information to the other wireless device. The BA frame that includes fast feedback information can be transmitted in an unsolicited or solicited manner and/or can be transmitted after a negotiation with the other wireless device to include fast feedback information in the BA frame. Fast feedback information can include at least a per stream effective signal to interference plus noise ratio (SINR) or SINR margin.

### PRIORITY INFORMATION

This application claims benefit of priority to U.S. Provisional Application Ser. No. 63/641,193, titled “Link Adaptation with Fast Feedback”, filed May 1, 2024, which is hereby incorporated by reference in its entirety as though fully and completely set forth herein.

### TECHNICAL FIELD

The present application relates to wireless communication, including techniques and devices for link adaptation with fast feedback in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. In a wireless local area network, it can be possible that certain traffic can be delayed while other communications in the network are being performed. This can potentially cause performance degradation for traffic for which low latency is important, at least in some instances. Accordingly, improvements in the field are desired.

### SUMMARY

Embodiments are presented herein of, inter alia, systems, apparatuses, and methods for devices to link adaptation with fast feedback in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links or can be an access point configured to establish a connection with one or more other wireless devices through a WLAN over one or multiple wireless links. In some embodiments, the wireless device can operate in each of the multiple wireless links using a respective radio of the one or more radios.

For example, in some embodiments, a wireless device can receive a physical protocol data unit (PPDU), e.g., from another wireless device such as from an access point. The wireless device can transmit a block acknowledgment (BA) frame that includes fast feedback information to the other wireless device. The BA frame that includes fast feedback information can be transmitted in an unsolicited or solicited manner and/or can be transmitted after a negotiation with the other wireless device to include fast feedback information in the BA frame. Fast feedback information can include at least a per stream effective signal to interference plus noise ratio (SINR) or SINR margin.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments.

FIG. 2 is a block diagram illustrating an example wireless device, according to some embodiments.

FIG. 3 is a block diagram illustrating an example network element or access point, according to some embodiments.

FIG. 4 is a block diagram illustrating an example modem or baseband processor, according to some embodiments.

FIGS. 5, 6, 7, 8, and 9 illustrate examples of signaling for supporting rate adaptation with fast feedback, according to some embodiments.

FIG. 10A illustrates an example of an ADDBA request frame, according to some embodiments.

FIG. 10B illustrates an example of an ADDBA response frame, according to some embodiments.

FIGS. 11 and 12 are flowchart diagrams illustrating example methods for performing link adaptation with fast feedback in a wireless local area network, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11 g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

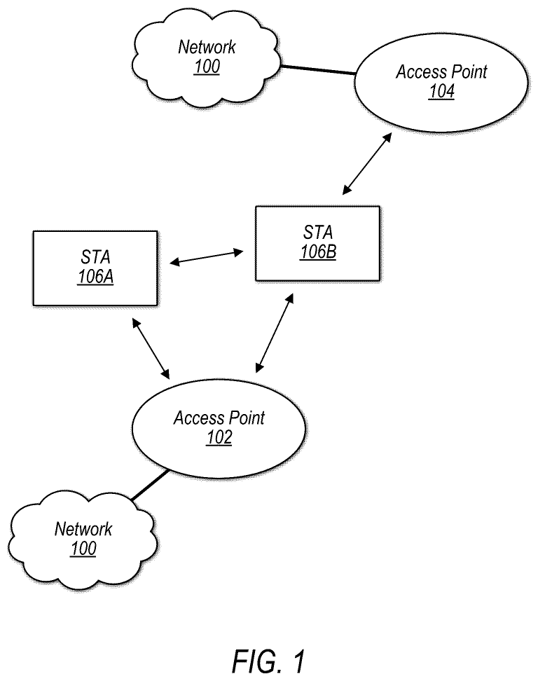

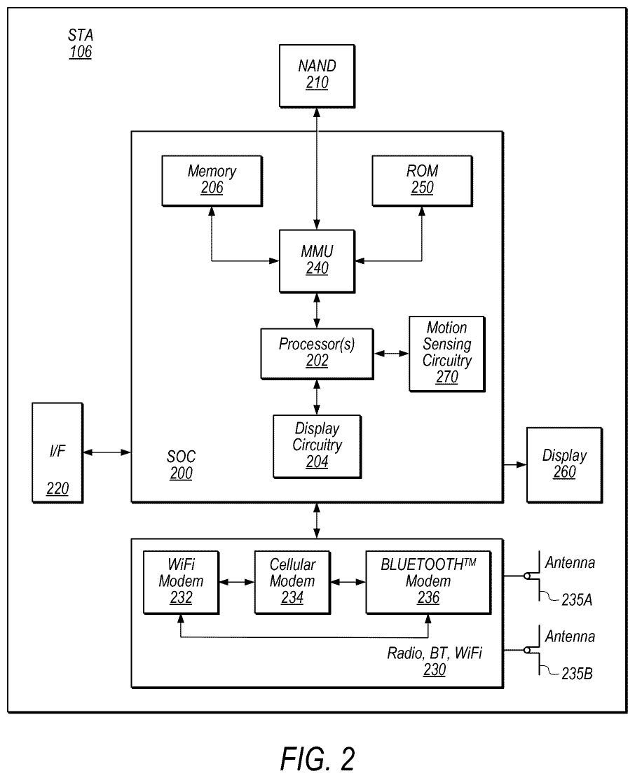

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for link adaptation with fast feedback in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for link adaptation with fast feedback described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

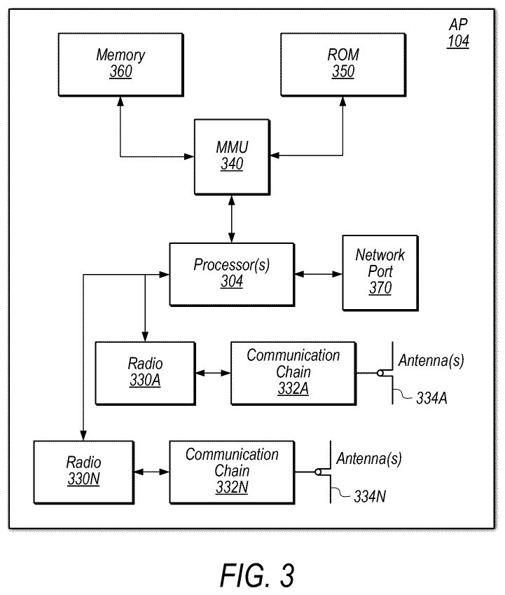

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as link adaptation with fast feedback, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

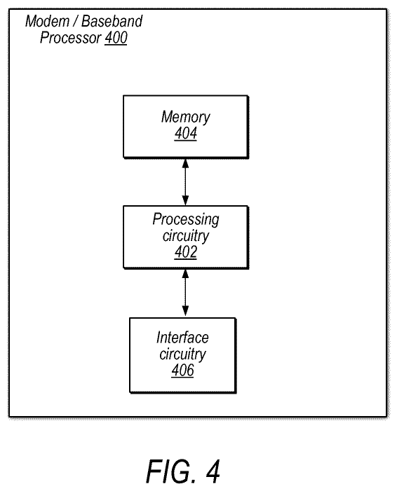

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as link adaptation with fast feedback, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

Link Adaptation with Fast Feedback

In current implementations of link adaptation algorithms, signal to interference plus noise ratio (SINR) is not tracked which can lead to throughput loss and potentially higher power consumption, such as when bursty interference is present. This issue is likely to worsen in IEEE 802.11bn Ultra high reliability (UHR) WiFi since new Modulation Coding Scheme (MCS) levels will be added and more unequal modulation (UEQM) patterns will be introduced.

In more detail, one issue with current implementations it that a rate of data transfer on a link may drop rapidly when channel conditions deteriorate and/or when a channel experiences interference, however, the rate may recover slowly when channel conditions improve and/or when interference dissipates or is gone. In IEEE 802.11bn, this issue may worsen since the introduction of new MCS levels may slow recovery further as there may be more MCS steps (e.g., from one level to another level) before converging to an optimal MCS level. Further, the addition of more UEQM patterns may further complicate recovery and may require knowledge of per stream SINR.

For example, in a scenario in which a channel is slowly varying without interference, a rate adaptation (e.g., link adaptation) algorithm can work well but can suffer from some throughput loss due to failed probing. In some cases, for a ten percent target packet error rate (PER), there can be an approximately ten percent throughput loss for auto rate fallback (ARF) and an approximately five percent throughput loss for adaptive ARF (AARF).

As another example, in a scenario in which there is random interference with an unknown schedule on a channel, there could be significant SINR variation that can impact a rate adaptation algorithm. In some cases, such as overlapping basic service set (OBSS) traffic on a primary channel, SINR could vary up to 20 decibels (dBs) depending on whether or not there is currently OBSS traffic. Further, since the traffic pattern varies for different applications, the impact of the rate adaptation algorithm can also vary. In other cases, such as bursty interference caused by de-sensing from co-located radios with a device can impact the rate adaptation algorithm as well. In these cases, current implementations of the rate adaptation algorithm have difficulty tracking fast and varying SINR changes. Hence, ARF and AARF can suffer from significant throughput loss due to failed SINR tracking resulting in a device staying with a lower MCS for a longer time than necessary given actual channel conditions.

As a further example, in a scenario in which there is a per special stream SINR change, there could be significant SINR variation that can impact a rate adaptation algorithm. In some cases, such as when one antenna of a device suffers from penetration loss due to hand grip, there can be a large per stream SINR difference between that antenna and another antenna not impacted by hand grip. Further, outdated channel state information (CSI) can degrade beamforming and also lead to an SINR gap among spatial streams. In current implementations, a rate adaptation algorithm can keep a current number of spatial streams (Nss) but drop an associated rate. In such a case, ARF and AARF can suffer from throughput loss due to MCS selection being restricted by a worst spatial stream.

Embodiments described herein improve link adaptation for devices by adding fast feedback in block acknowledgements (BAs). In particular, embodiments described herein include solutions for a fast feedback protocol, content to feedback, and schemes for how to build up trust between a transmitter and a receiver as well as how to allow more processing time at the receiver side. In particular, embodiments described herein provide solutions for a fast feedback protocol framework, such as how to negotiate, order, enable, and/or disable fast feedback, as well as what information to include in feedback and how to carry/transmit such feedback. In addition, embodiments described herein provide solutions for resolving trust issues between a transmitting device and receiving device (e.g., such as whether feedback is accurate and/or whether fast feedback will improve subsequent transmissions) as well as how to increase processing time for fast feedback (e.g., if and/or when processing time increases beyond a short interframe space (SIFS) time frame).

In some instances, as part of a fast feedback (FFb) protocol, FFb can be added in a block acknowledgement (BA) frame. Further, FFb can also be added in a multi-station BA (MBA) frame. In other words, FFb can be carried by a BA frame and/or by an MBA frame. Additionally, as part of the FFb protocol, FFb can be unsolicited (e.g., added by a receiving device as needed), solicited (e.g., requested by a transmitting device as needed), and/or negotiated as part of a BA agreement (e.g., at the time of BA establishment between a receiving device and a transmitted device).

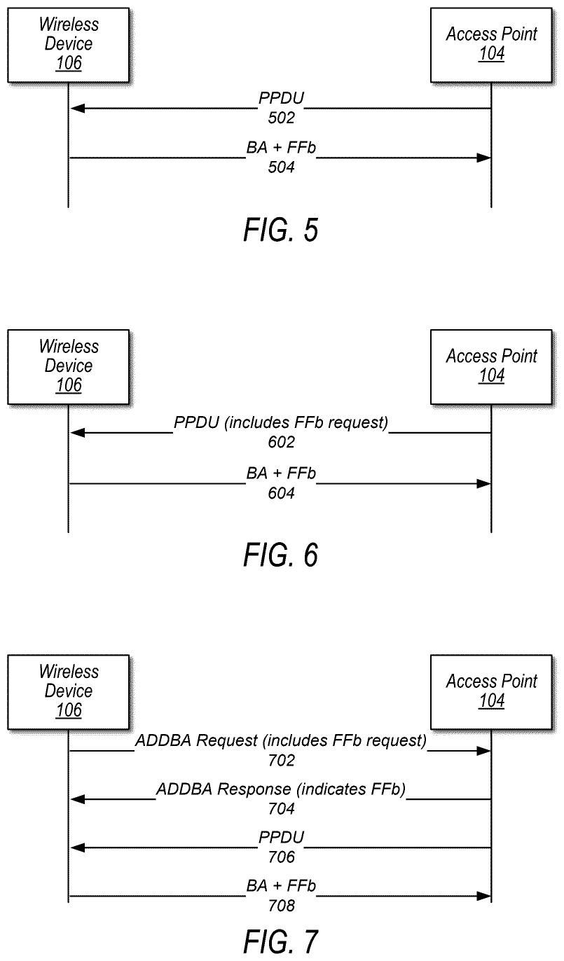

For example, FIGS. 5, 6, 7, 8, and 9 illustrate examples of signaling for supporting rate adaptation with FFb, according to some embodiments. In particular, FIGS. 5, 6, and 7 illustrate examples of signaling for supporting rate adaptation with immediate FFb and FIGS. 8 and 9 illustrate examples of signaling for supporting rate adaptation with delayed FFb. In various embodiments, some of the signaling shown can be performed concurrently, in a different order than shown, can be substituted for by one or more other signals, or can be omitted. Additional signaling can also be performed as desired.

Aspects of the signaling of FIGS. 5, 6, 7, 8, and 9 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated signaling elements and/or other signaling.

Note that while at least some of the signaling of FIGS. 5, 6, 7, 8, and 9 are described in a manner relating to the use of communication techniques and/or features associated with IEEE 802.11 specification documents, such description is not intended to be limiting to the disclosure, and aspects of the signaling of FIGS. 5, 6, 7, 8, and 9 can be used in any suitable wireless communication system, as desired. Turning to FIG. 5, as shown, the signaling can operate as follows.

At 502, a wireless device and/or a baseband processor of a wireless device, such as wireless device 106, can receive a physical protocol data unit (PPDU) from an access point and/or a baseband processor of an access point, such as access point 104.

At 504, the wireless device and/or the baseband processor of the wireless device can transmit a block acknowledgment (BA) frame that includes fast feedback (FFb) to the access point and/or baseband processor of the access point, e.g., in an unsolicited manner. In other words, the wireless device and/or baseband processor of the wireless device can decide and/or determine to include FFb in and/or with the BA frame. As noted above, the FFb can be carried in multi-station BA (MBA) frame as well as a BA frame. In an MBA frame, the FFb can be included using a reserved Ack Type and TID combination in a per AID TID info subfield. Further, a block ACK bitmap field in the MBA can be redefined as FFb information.

Turning to FIG. 6, as shown, the signaling can operate as follows.

At 602, a wireless device and/or a baseband processor of a wireless device, such as wireless device 106, can receive a physical protocol data unit (PPDU) from an access point and/or a baseband processor of an access point, such as access point 104. The PPDU can include a request for FFb feedback. For example, a header of the PPDU can include an FFb request bit and the access point can use the FFb request bit to indicate/order FFb in a responding BA.

At 604, the wireless device and/or the baseband processor of the wireless device can transmit a block acknowledgment (BA) frame that includes fast feedback (FFb) to the access point and/or baseband processor of the access point, e.g., in a solicited manner. In other words, the wireless device and/or baseband processor of the wireless device can decide and/or determine to include FFb in and/or with the BA frame based on receiving an indication in the PPDU to provide FFb. As noted above, the FFb can be carried in multi-station BA (MBA) frame as well as a BA frame. In an MBA frame, the FFb can be included using a reserved Ack Type and TID combination in a per AID TID info subfield. Further, a block ACK bitmap field in the MBA can be redefined as FFb information.

Turning to FIG. 7, as shown, the signaling can operate as follows.

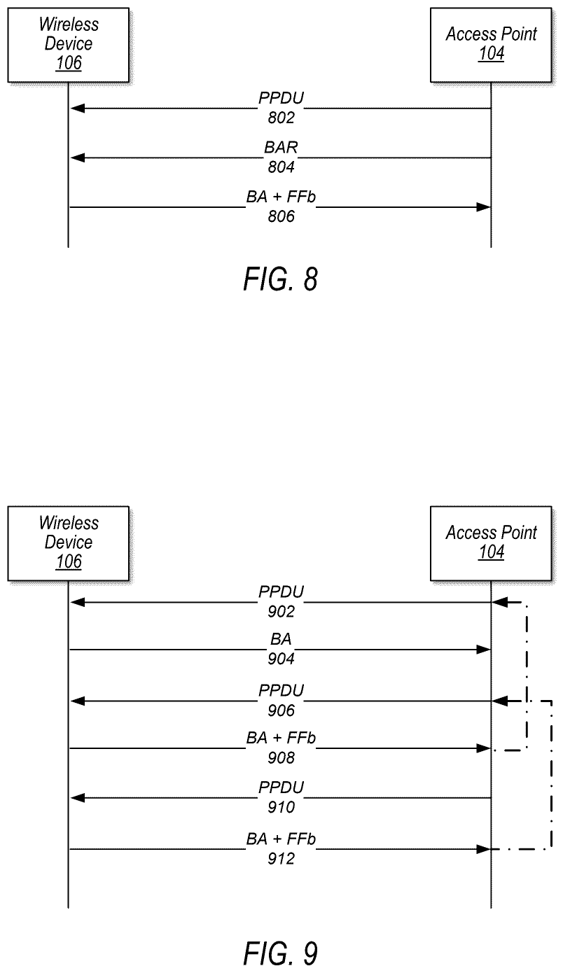

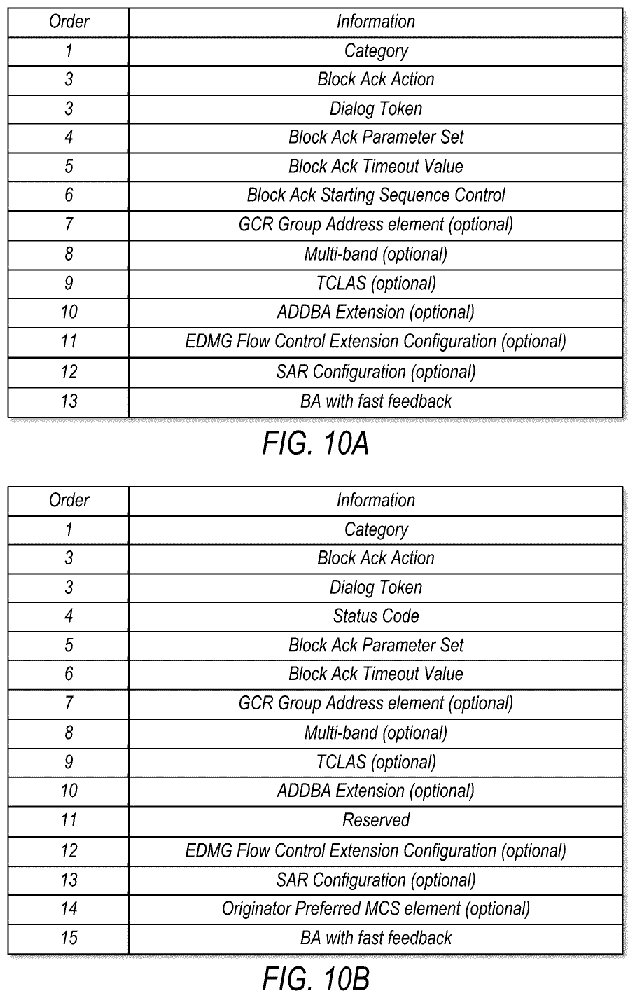

At 702, a wireless device and/or a baseband processor of a wireless device, such as wireless device 106, can transmit an add block acknowledgment (ADDBA) request frame to an access point and/or a baseband processor of an access point, such as access point 104. As illustrated in FIG. 10A, the ADDBA request frame can include, among other fields, a BA with fast feedback field/indicator. Such a field/indicator can be used to request fast feedback (FFb).

At 704, the wireless device and/or baseband processor of the wireless device can receive an ADDBA response frame from the access point and/or baseband processor of the access point. As shown in FIG. 10B, the ADDBA response frame can include, among other fields, a BA with fast feedback field/indicator. Such a field/indicator can be used to indicate whether the wireless device can use FFb. For example, in some instances, such a field can include 1 bit to indicate whether FFb can be included in/with a BA and 1 bit to indicate whether a negative acknowledgement (NACK) can be reported in a BA when all MAC protocol data units (MPDUs) fail. In addition, such a field can include one or more bits indicating whether the FFb can be delayed (e.g., delayed FFb or immediate FFb). In addition, such a field can include additional subfields such as AID TID information used for FFb in an MBA.

At 706, the wireless device and/or baseband processor of the wireless device can receive a physical protocol data unit (PPDU) from the access point and/or the baseband processor of the access point.

At 708, the wireless device and/or the baseband processor of the wireless device can transmit a block acknowledgment (BA) frame that includes FFb to the access point and/or baseband processor of the access point, e.g., based on negotiating that FFb can be included in/with the BA frame. As noted above, the FFb can be carried in multi-station BA (MBA) frame as well as a BA frame. In an MBA frame, the FFb can be included using a reserved Ack Type and TID combination in a per AID TID info subfield. Further, a block ACK bitmap field in the MBA can be redefined as FFb information.

Turning to FIG. 8, as shown, the signaling can operate as follows.

At 802, a wireless device and/or a baseband processor of a wireless device, such as wireless device 106, can receive a physical protocol data unit (PPDU) from an access point and/or a baseband processor of an access point, such as access point 104.

At 804, the wireless device and/or the baseband processor of the wireless device can receive, from the access point and/or baseband processor of the access point, a block acknowledgment request (BAR) frame.

At 806, the wireless device and/or the baseband processor of the wireless device can transmit a block acknowledgment (BA) frame that includes fast feedback (FFb) to the access point and/or baseband processor of the access point, e.g., in a delayed manner. In other words, the wireless device and/or baseband processor of the wireless device may not be capable of providing an immediate BA with FFb, which would require the BA with FFb to occur a short interframe space (SIFS) after measurement of the received PPDU. Thus, in some instances, prior to receiving the PPDU, the wireless device and/or baseband processor of the wireless device can indicate a FFb capability to the access point and/or baseband processor of the access point. For example, the wireless device and/or baseband processor of the wireless device may only support an immediate BA with FFb for up to a maximum bandwidth (BW) and a maximum number of Nss. Thus, in some instances, the FFb capability can be defined as a threshold for <BW, Nss> combinations. As noted above, the FFb can be carried in multi-station BA (MBA) frame as well as a BA frame. In an MBA frame, the FFb can be included using a reserved Ack Type and TID combination in a per AID TID info subfield. Further, a block ACK bitmap field in the MBA can be redefined as FFb information.

Turning to FIG. 9, as shown, the signaling can operate as follows.

At 902, a wireless device and/or a baseband processor of a wireless device, such as wireless device 106, can receive a physical protocol data unit (PPDU) from an access point and/or a baseband processor of an access point, such as access point 104.

At 904, the wireless device and/or the baseband processor of the wireless device can transmit, to the access point and/or baseband processor of the access point, a block acknowledgment (BA) frame.

At 906, the wireless device and/or the baseband processor of the wireless device can receive, from the access point and/or baseband processor of the access point, another PPDU.

At 908, the wireless device and/or the baseband processor of the wireless device can transmit, to the access point and/or baseband processor of the access point, a BA frame with FFb for the PPDU received at 904 when the PPDU at 906 is received within a timeout period from the access point and/or baseband processor of the access point.

At 910, the wireless device and/or the baseband processor of the wireless device can receive, from the access point and/or baseband processor of the access point, another PPDU.

At 912, the wireless device and/or the baseband processor of the wireless device can transmit, to the access point and/or baseband processor of the access point, a BA frame with FFb for the PPDU received at 906 when the PPDU at 910 is received within a timeout period from the access point and/or baseband processor of the access point.

Note that in some instances, different PPDUs (e.g., PPDUs 902, 906 and 910) can have different transmit power, a different number of spatial streams, and/or different MCS levels. Thus, measurements from different PPDUs can be different and if the feedback is effective per stream SINR of the Nss and MCS used in the measured PPDU, the transmitter side (e.g., access point) needs to know which PPDU the FFb is measured from, hence, if, as in FIGS. 8 and 9, the FFb is not fed back in an immediate BA, the FFb needs to include some signaling/information to link the FFb to a particular PPDU. For example, a PPDU sequence number (SN) can be included in a preamble of the PPDU and the FFb can include the PPDU SN to link the FFb to the PPDU. As another example, PPDUs received within a timeout period can use different scrambling seeds and a PPDU carrying the BA with FFb can use the same scrambling seed to link the FFb to a particular PPDU. As a further example, a portion of a preamble of a PPDU can be used as a PPDU signature and the FFb linked to a particular PPDU can include the PPDU signature of the particular PPDU. The PPDU signature can be bits from the preamble such as a L_Length field in an L_SIG field, a cyclic redundancy check (CRC) field of a universal signal (U-SIG) field or a ultra-high reliability signal (UHR-SIG) field, a combination of a CRC field of both a U-SIG field and a UHR-SIG field, a combination of disregard bits, and/or a CRC field plus 1 or 2 disregard bits in case there are CRC field conflicts. As a yet further example, signature bits of a PPDU can be included in a data field of the PPDU and the FFb linked to a particular PPDU can include the signature bits included in the data field of the particular PPDU. As another example, signature bits of a PPDU can be a PPDU identifier included in a medium access control (MAC) header of the PPDU or a Galois Counter Mode Protocol (GCMP) header of the PPDU and the FFb linked to a particular PPDU can include the PPDU identifier included in the MAC header or GCMP header of the particular PPDU.

In the signaling described here, the FFb can include any, any combination of, and/or all of (e.g., one or more of and/or at least one of) a recommended number of spatial streams (Nss), a recommended modulation and coding scheme (MCS) index and/or level, and/or a recommended anchor MCS index and/or level plus a recommended unequal modulation (UEQM) pattern. In addition, the FFb can include a per stream effective signal to interference plus noise ratio (SINR) based, at least in part, on a modulation level applied on each stream. For example, the FFb can include a recommended Nss and a recommended MCS index/level as well as a per stream effective SINR. As another example, the FFb can include a recommended Nss, an anchor MCS index/level and a UEQM pattern as well as a per stream effective SINR.
In some instances, FFb can include any, any combination of, and/or all of (e.g., one or more of and/or at least one of) a recommended MCS index/level and/or an anchor MCS index/level plus a recommended UEQM pattern for an Nss used in the received and measured PPDU. In addition, the FFb can include a per stream effective SINR based, at least in part, on a modulation level applied on each stream. In such instances, Nss feedback may not be necessary, and thus, not included in FFb, since Nss can be implied by the per stream effective SINR. For example, the FFb can include a recommended MCS index/level as well as a per stream effective SINR. As another example, the FFb can include an anchor MCS index/level and a UEQM pattern as well as a per stream effective SINR.

In some instances, FFb can include any, any combination of, and/or all of (e.g., one or more of and/or at least one of) a recommended number of spatial streams (Nss), a recommended modulation and coding scheme (MCS) index and/or level or an anchor MCS index and/or level, and/or a recommended unequal modulation (UEQM) pattern. In addition, the FFb can include a per stream effective SINR margin. The per stream SINR margin can be defined as a per stream effective SINR minus a required effective SINR for an MCS on that stream. In some instances, Nss feedback may not be necessary, and thus, not included in FFb, since Nss can be implied by the per stream effective SINR margin. In some instances, the FFb can change to a recommended optimal MCS and/or anchor MCS and a recommended UEQM pattern. For example, the FFb can include a recommended Nss, a recommended MCS index/level, and a UEQM pattern as well as a per stream effective SINR margin. As another example, the FFb can include a recommended Nss, an anchor MCS index/level, and a UEQM pattern as well as a per stream effective SINR margin. As a further example, the FFb can include a recommended MCS index/level and UEQM pattern as well as a per stream effective SINR margin. As yet another example, the FFb can include an anchor MCS index/level and a UEQM pattern as well as a per stream effective SINR margin.

In some instances, the FFb can include a per stream effective SINR for a current MCS/Nss combination. In some instances, the FFb can include a per stream effective SINR margin for a current MCS/NSS combination. In other words, the only feedback information included in the FFb can be a such instances, the FFb can be a per stream effective SINR or effective SINR margin for a current MCS/Nss combination.

In some instances, the FFb can include a reference MCS as well as a per stream effective SINR or effective SINR margin for the reference MCS and a current Nss. Note that the reference MCS can be indicated as a delta MCS or a delta anchor MCS. For example, the reference MCS can be an increase in one MCS level from a current MCS level. As another example, the reference MCS can be a decrease in one MCS level from the current MCS level. In other words, the reference MCS may not be a recommended optimal MCS, instead the reference MCS can be an indication to probe a higher or lower MCS level, where the effective per stream SINR/SINR margin is for the probing MCS level.

In addition to the above instances, FFb feedback can be further enhanced to include an interference pattern and/or probing recommendation. Such information can indicate whether the wireless device (e.g., receiving device) is experiencing frequent varying interference or short bursty interference. Note that directly using MCS feedback when the wireless device is experiencing short bursty interference can negatively impact performance. Further, such information can indicate whether the access point (e.g., transmitting device) is recommended to directly use the MCS provided in the FFb or to treat the FFb as probing recommendation or suggestion for the transmitter to filter multiple FFb. For example, the FFb can include 1 bit to indicate direct use of the FFb or use of the FFb as probing recommendation instead. In other words, the FFb can include a 1-bit flag to indicate how to apply the FFb, e.g., when the flag has a value of 1, the FFb can be directly used and when the flag has a value of 0, the FFb can be used as a probing recommendation. Alternatively, when the flag has a value of 0, the FFb can be directly used and when the flag has a value of 1, the FFb can be used as a probing recommendation.

Note that in the above descriptions, unequal modulation can allow different modulation levels for different spatial streams but all spatial streams can still use joint encoding and a same code rate. Note further that the anchor MCS can be considered an MCS for the first (or strongest) spatial stream and other spatial streams will use the same coding rate as the anchor MCS but may use lower modulation level. Thus, a UEQM pattern is a pattern of modulations across multiple spatial streams. For example, for three spatial beams, the pattern can be a first quadrature amplitude modulation (QAM) which corresponds to the anchor MCS (e.g., such as 64QAM), a second QAM which can be a repeat of the first QAM, and a third QAM which can be one QAM less than the first QAM (e.g., if the first QAM is 64 QAM, one less QAM is 16QAM). As another example, for two spatial beams, the pattern can be a first quadrature amplitude modulation (QAM) which corresponds to the anchor MCS (e.g., such as 64QAM and a second QAM which can be one QAM less than the first QAM (e.g., if the first QAM is 64 QAM, one less QAM is 16QAM).

Note further that in the above descriptions, per beam effective SINR can be defined as:

$$\begin{matrix}{SNIR}_{eff , k} = {Φ}^{- 1} ( {RBIR}_{k} ; M ) \\ {RBIR}_{k} = \frac{1}{N \cdot T} {\sum }_{t = 1}^{T} {\sum }_{n = 1}^{N} Φ ( SNIR ( k , n , t ) ; M ) \\ Φ ( SINR ; M ) = {log}_{2} M - \frac{1}{M} {\sum }_{m = 1}^{M} {E}_{U} \{ {log}_{2} ( {\sum }_{k = 1}^{M} exp [ ( {\vert U \vert}^{2} - {\vert \sqrt{SINR} ( {s}_{k} - {s}_{m} ) + U \vert}^{2} ) ] ) \}\end{matrix}$$

where U is a zero mean complex Gaussian random variable with variance 1, N is a total number of tones, T is a total number of orthogonal frequency division modulation (OFDM) symbols, and RBIR is received bit mutual information rate.

Thus, according to the signaling of FIGS. 5, 6, 7, 8, and 9, it can be possible to provide fast feedback in a WLAN setting, for example to provide better rate adaptation during various interference events. Such techniques can reduce throughput loss and improve power consumption during such events, at least according to some embodiments.

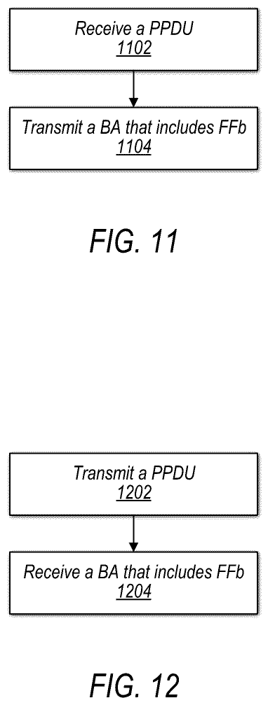

FIGS. 11 and 12 are flowchart diagrams illustrating example methods for performing link adaptation with fast feedback in a wireless local area network, according to some embodiments. In various embodiments, some of the elements shown can be performed concurrently, in a different order than shown, can be substituted for by one or more other elements, or can be omitted. Additional elements can also be performed as desired.

Aspects of the elements of FIGS. 11 and 12 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated elements and/or other elements.

Note that while at least some of the elements of FIGS. 11 and 12 are described in a manner relating to the use of communication techniques and/or features associated with IEEE 802.11 specification documents, such description is not intended to be limiting to the disclosure, and aspects of the elements of FIGS. 11 and 12 can be used in any suitable wireless communication system, as desired. Turning to FIG. 11, as shown, the method can operate as follows.

At 1102, a wireless device and/or a baseband processor of a wireless device, such as wireless device 106, can receive a physical protocol data unit (PPDU), e.g., from another wireless device such as from an access point and/or a baseband processor of an access point, such as access point 104.

At 1104, the wireless device and/or baseband process of the wireless device can transmit a block acknowledgment (BA) frame that includes fast feedback information to the other wireless device.

In some instances, in response to receiving the PPDU, the wireless device and/or the baseband processor of the wireless device can determine to include the fast feedback information in the BA frame. The determination to include the fast feedback information in the BA frame can be based, at least in part, on a detected interference pattern. In at least some instances, the detected interference pattern can be stable interference across a plurality of received PPDUs.

In some instances, the PPDU can include a fast feedback information request in a physical header of the PPDU. In such instances, the fast feedback information request can be indicated by a bit in the physical header of the PPDU. Further, the BA frame that includes fast feedback information can be transmitted based, at least in part, on the PPDU including the fast feedback information request.

In some instances, prior to receiving the PPDU, the wireless device and/or the baseband processor of the wireless device can transmit an add BA (ADDBA) request frame that includes a request to use fast feedback information and receive an ADDBA response frame that includes a confirmation to include fast feedback information in the BA frame. The ADDBA request frame can include a BA with fast feedback field to indicate the request to use fast feedback information. Further, the ADDBA response frame can include a BA with fast feedback field to indicate the confirmation to include fast feedback information in the BA frame. In addition, the BA with fast feedback field can include at least one of one bit indicating whether or not to include fast feedback in a BA frame, one bit indicating whether or not to include a negative acknowledgment (NACK) report in a BA frame when all medium access control (MAC) protocol data unites (MPDUs) fail, and/or one bit indicating whether the fast feedback information is immediate or delayed. Additionally, the BA with fast feedback field can further include one or more subfields, such as a special association identifier (AID)—traffic identifier (TID) information used for fast feedback in a multi-station BA (MBA) frame.

In some instances, prior to transmitting the BA frame that includes fast feedback information, the wireless device and/or the baseband processor of the wireless device can receive a block acknowledgment request (BAR) frame. In such instances, the BA frame that includes fast feedback information can be transmitted in response to receiving the BAR frame.

In some instances, prior to transmitting the BA frame that includes fast feedback information, the wireless device and/or the baseband processor of the wireless device can receive an additional PPDU within a specified timeout period associated with receipt of the PPDU. In such instances, the BA frame that includes fast feedback information can identify that the fast feedback information is linked to the PPDU. For example, to identify that the fast feedback is linked to the PPDU, the fast feedback information can include a sequence number included in a preamble of the PPDU, can be scrambled using a scrambling seed used to scramble the PPDU, can include signature bits included in a preamble of the PPDU, can include signature bits included in a data field of the PPDU, can include a PPDU identifier included in a medium access control (MAC) header of the PPDU, and/or can include a PPDU identifier included in a Galois Counter Mode Protocol (GCMP) header of the PPDU.

In some instances, prior to receiving the PPDU, the wireless device and/or the baseband processor of the wireless device can transmit a capability indicating when immediate fast feedback is supported. The capability can be defined as a threshold of bandwidth and a number of spatial streams (Nss) combinations. For example, for bandwidth and Nss combinations exceeding the threshold, delayed fast feedback can be supported. As another example, for bandwidth and Nss combinations not exceeding the threshold, immediate fast feedback can be supported.

In some instances, the fast feedback information can include a per stream effective signal to interference plus noise ratio (SINR). The SINR can be based, at least in part, on a modulation level applied on each stream. In such instances, the fast feedback information can further include a recommended modulation and coding scheme (MCS) index or level or an anchor MSC index or level and a recommended unequal modulation (UEQM) pattern. In some instances, the fast feedback information can further include a recommended number of spatial streams (Nss). In addition, the fast feedback information can further include a recommended MCS index or level for an Nss used to receive and measure the PPDU. Additionally, the fast feedback information can further include an anchor MCS index or level and a UEQM pattern for an Nss used to receive and measure the PPDU.

In some instances, the fast feedback information can include a per stream effective signal to interference plus noise ratio (SINR) margin. The SINR margin can be defined as a per stream effective SINR minus a required effective SINR for an MCS on that stream. Further, the SINR margin can be based, at least in part, on a modulation level applied on each stream. In some instances, the fast feedback information can further include a recommended MCS index or level or an anchor MSC index or level and a recommended UEQM pattern. In some instances, the fast feedback information can further include a recommended Nss. In addition, the fast feedback information can further include a recommended MCS index or level for an Nss used to receive and measure the PPDU. Additionally, the fast feedback information can further include an anchor MCS index or level and a UEQM pattern for an Nss used to receive and measure the PPDU.

In some instances, the fast feedback information can include a per stream effective signal to interference plus noise ratio (SINR) for a current modulation and coding scheme (MCS) and number of spatial streams (Nss).

In some instances, the fast feedback information can include a per stream effective signal to interference plus noise ratio (SINR) margin for a current modulation and coding scheme (MCS) and number of spatial streams (Nss). In such instances, the effective SINR margin can be based, at least in part, on a modulation level applied on each stream.

In some instances, the fast feedback information can include a per stream effective signal to interference plus noise ratio (SINR) or SINR margin for a reference modulation and coding scheme (MCS) and number of spatial streams (Nss). The effective SINR margin can be based, at least in part, on a modulation level applied on each stream. In addition, the reference MCS can be indicated as a delta MCS or a delta anchor MCS. In some instances, the reference MCS can be a one level increase or one level decrease from a current MCS level.

In some instances, the fast feedback information can include one or more of an interference pattern or a probing recommendation. In such instances, the interference pattern can indicate whether interference is relatively stable across a plurality of received PPDUs, frequently varying across the plurality of received PPDUs, or short, bursty interference. Further, the fast feedback information can include 1 bit indicating whether to directly use of the fast feedback information for link adaptation or to use of the fast feedback as a probing recommendation.

Turning to FIG. 12, as shown, the method can operate as follows.

At 1202, a wireless device and/or a baseband processor of a wireless device, such as access point 104, can transmit a physical protocol data unit (PPDU), e.g., to another wireless device such as to a wireless device and/or a baseband processor of a wireless device, such as wireless device 106.

At 1204, the wireless device and/or baseband process of the wireless device can receive a block acknowledgment (BA) frame that includes fast feedback information from the other wireless device.

In some instances, the BA frame that includes fast feedback information can be received unsolicited. In other instances, the BA frame that includes fast feedback information can be received solicited. For example, the PPDU can include a fast feedback information request in a physical header of the PPDU. In such instances, the fast feedback information request can be indicated by a bit in the physical header of the PPDU. Further, the BA frame that includes fast feedback information can be received based, at least in part, on the PPDU including the fast feedback information request.

In some instances, prior to transmitting the PPDU, the wireless device and/or the baseband processor of the wireless device can receive an add BA (ADDBA) request frame that includes a request to use fast feedback information and transmit an ADDBA response frame that includes a confirmation to include fast feedback information in the BA frame. The ADDBA request frame can include a BA with fast feedback field to indicate the request to use fast feedback information. Further, the ADDBA response frame can include a BA with fast feedback field to indicate the confirmation to include fast feedback information in the BA frame. In addition, the BA with fast feedback field can include at least one of one bit indicating whether or not to include fast feedback in a BA frame, one bit indicating whether or not to include a negative acknowledgment (NACK) report in a BA frame when all medium access control (MAC) protocol data unites (MPDUs) fail, and/or one bit indicating whether the fast feedback information is immediate or delayed. Additionally, the BA with fast feedback field can further include one or more subfields, such as a special association identifier (AID)—traffic identifier (TID) information used for fast feedback in a multi-station BA (MBA) frame.

In some instances, prior to receiving the BA frame that includes fast feedback information, the wireless device and/or the baseband processor of the wireless device can transmit a block acknowledgment request (BAR) frame. In such instances, the BA frame that includes fast feedback information can be received in response to transmitting the BAR frame.

In some instances, prior to receiving the BA frame that includes fast feedback information, the wireless device and/or the baseband processor of the wireless device can transmit an additional PPDU within a specified timeout period associated with transmission of the PPDU. In such instances, the BA frame that includes fast feedback information can identify that the fast feedback information is linked to the PPDU. For example, to identify that the fast feedback is linked to the PPDU, the fast feedback information can include a sequence number included in a preamble of the PPDU, can be scrambled using a scrambling seed used to scramble the PPDU, can include signature bits included in a preamble of the PPDU, can include signature bits included in a data field of the PPDU, can include a PPDU identifier included in a medium access control (MAC) header of the PPDU, and/or can include a PPDU identifier included in a Galois Counter Mode Protocol (GCMP) header of the PPDU.

In some instances, prior to transmitting the PPDU, the wireless device and/or the baseband processor of the wireless device can receive a capability indicating when immediate fast feedback is supported. The capability can be defined as a threshold of bandwidth and a number of spatial streams (Nss) combinations. For example, for bandwidth and Nss combinations exceeding the threshold, delayed fast feedback can be supported. As another example, for bandwidth and Nss combinations not exceeding the threshold, immediate fast feedback can be supported.

In some instances, the fast feedback information can include a per stream effective signal to interference plus noise ratio (SINR). The SINR can be based, at least in part, on a modulation level applied on each stream. In such instances, the fast feedback information can further include a recommended modulation and coding scheme (MCS) index or level or an anchor MSC index or level and a recommended unequal modulation (UEQM) pattern. In some instances, the fast feedback information can further include a recommended number of spatial streams (Nss). In addition, the fast feedback information can further include a recommended MCS index or level for an Nss used to receive and measure the PPDU. Additionally, the fast feedback information can further include an anchor MCS index or level and a UEQM pattern for an Nss used to receive and measure the PPDU.

In some instances, the fast feedback information can include a per stream effective signal to interference plus noise ratio (SINR) margin. The SINR margin can be defined as a per stream effective SINR minus a required effective SINR for an MCS on that stream. Further, the SINR margin can be based, at least in part, on a modulation level applied on each stream. In some instances, the fast feedback information can further include a recommended MCS index or level or an anchor MSC index or level and a recommended UEQM pattern. In some instances, the fast feedback information can further include a recommended Nss. In addition, the fast feedback information can further include a recommended MCS index or level for an Nss used to receive and measure the PPDU. Additionally, the fast feedback information can further include an anchor MCS index or level and a UEQM pattern for an Nss used to receive and measure the PPDU.

In some instances, the fast feedback information can include a per stream effective signal to interference plus noise ratio (SINR) for a current modulation and coding scheme (MCS) and number of spatial streams (Nss).

In some instances, the fast feedback information can include a per stream effective signal to interference plus noise ratio (SINR) margin for a current modulation and coding scheme (MCS) and number of spatial streams (Nss). In such instances, the effective SINR margin can be based, at least in part, on a modulation level applied on each stream.

In some instances, the fast feedback information can include a per stream effective signal to interference plus noise ratio (SINR) or SINR margin for a reference modulation and coding scheme (MCS) and number of spatial streams (Nss). The effective SINR margin can be based, at least in part, on a modulation level applied on each stream. In addition, the reference MCS can be indicated as a delta MCS or a delta anchor MCS. In some instances, the reference MCS can be a one level increase or one level decrease from a current MCS level.

In some instances, the fast feedback information can include one or more of an interference pattern or a probing recommendation. In such instances, the interference pattern can indicate whether interference is relatively stable across a plurality of received PPDUs, frequently varying across the plurality of received PPDUs, or short, bursty interference. Further, the fast feedback information can include 1 bit indicating whether to directly use of the fast feedback information for link adaptation or to use of the fast feedback as a probing recommendation.

Thus, according to the methods of FIGS. 11 and 12, it can be possible to provide fast feedback in a WLAN setting, for example to provide better rate adaptation during various interference events. Such techniques can reduce throughput loss and improve power consumption during such events, at least according to some embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for providing fast feedback, comprising:
receiving, from a wireless device, a physical protocol data unit (PPDU); and
transmitting, to the wireless device, a block acknowledgment (BA) frame that includes fast feedback information.

2. The method of claim 1, further comprising:
determining, in response to receiving the PPDU and based, at least in part on a detected interference pattern, to include the fast feedback information in the BA frame.

3. The method of claim 2,
wherein the detected interference pattern comprises stable interference across a plurality of received PPDUs.

4. The method of claim 1,
wherein the PPDU includes a fast feedback information request in a physical header of the PPDU; and
wherein the fast feedback information request is indicated by a bit in the physical header of the PPDU.

5. The method of claim 1, further comprising:
transmitting, prior to receiving the PPDU, a add BA (ADDBA) request frame that includes a request to use fast feedback information; and
receiving, prior to receiving the PPDU, an ADDBA response frame that includes a confirmation to include fast feedback information in the BA frame.

6. The method of claim 5,
wherein the ADDBA request includes a BA with a fast feedback field to indicate the request to use fast feedback information.

7. The method of claim 5,
wherein the ADDBA response includes a BA with a fast feedback field to indicate the confirmation to include fast feedback information in the BA frame.

8. The method of claim 6,
wherein the BA with fast feedback field includes at least one of:
one bit indicating whether or not to include fast feedback in a BA frame;
one bit indicating whether or not to include a negative acknowledgment (NACK) report in a BA frame when all medium access control (MAC) protocol data unites (MPDUs) fail; or
one bit indicating whether the fast feedback information is immediate or delayed.

9. The method of claim 8,
wherein the BA with fast feedback field further includes one or more subfields, wherein the one or more subfields include at least special association identifier (AID)—traffic identifier (TID) information used for fast feedback in a multi-station BA (MBA) frame.

10. An apparatus, comprising:
a memory; and
at least one processor in communication with the memory and configured to:
receive, from a wireless device, a physical protocol data unit (PPDU); and
generate instructions to transmit, to the wireless device, a block acknowledgment (BA) frame that includes fast feedback information.

11. The apparatus of claim 10,
wherein the at least one processor is further configured to:
receive, prior to transmitting the BA frame that includes fast feedback information, a block acknowledgment request (BAR) frame; and
wherein the BA frame that includes fast feedback information is transmitted in response to receiving the BAR frame.

12. The apparatus of claim 10,
wherein the at least one processor is further configured to:
receive, prior to transmitting the BA frame that includes fast feedback information, an additional PPDU within a specified timeout period associated with receipt of the PPDU; and
wherein the BA frame that includes fast feedback information identifies that the fast feedback information is linked to the PPDU.

13. The apparatus of claim 12,
wherein to identify that the fast feedback is linked to the PPDU:
the fast feedback information includes a sequence number included in a preamble of the PPDU;
the BA frame that includes fast feedback information is scrambled using a scrambling seed used to scramble the PPDU;
the fast feedback information includes at least one of:
signature bits included in a preamble of the PPDU;
signature bits included in a data field of the PPDU;
a PPDU identifier included in a medium access control (MAC) header of the PPDU; or
a PPDU identifier included in a Galois Counter Mode Protocol (GCMP) header of the PPDU.

14. The apparatus of claim 10,
wherein the at least one processor is further configured to:
generation instructions to transmit, prior to receiving the PPDU, a capability indicating when immediate fast feedback is supported.

15. The apparatus of claim 14,
wherein the capability is defined as a threshold of bandwidth and a number of spatial streams (Nss) combinations; and
wherein, for bandwidth and Nss combinations exceeding the threshold, delayed fast feedback is supported.

16. A non-transitory computer readable memory medium storing program instructions executable by processing circuitry to:
receive, from a wireless device, a physical protocol data unit (PPDU); and
transmit, to the wireless device, a block acknowledgment (BA) frame that includes fast feedback information.

17. The non-transitory computer readable memory medium of claim 16,
wherein the fast feedback information includes a per stream effective signal to interference plus noise ratio (SINR) that is based, at least in part, on a recommended modulation level applied on each stream and one or more of:
a recommended modulation and coding scheme (MCS) index or level.
an anchor MCS index or level and a recommended unequal modulation (UEQM) pattern;
a recommended number of spatial streams (Nss);
a recommended MCS index or level for an Nss used to receive and measure the PPDU; or
an MCS index or level and a UEQM pattern for an Nss used to receive and measure the PPDU.

18. The non-transitory computer readable memory medium of claim 16,
wherein the fast feedback information includes a per stream effective signal to interference plus noise ratio (SINR) margin that is defined as a per stream effective SINR minus a required effective SINR for a modulation and coding scheme (MCS) on that stream and one or more of:
a recommended MCS index or level;
an anchor MCS index or level and a recommended unequal modulation (UEQM) pattern;
a recommended number of spatial streams (Nss);
a recommended MCS index or level for an Nss used to receive and measure the PPDU;
an anchor MCS index or level and a UEQM pattern for an Nss used to receive and measure the PPDU;
a per stream effective SINR for a current MCS and Nss; or
a per stream effective SINR margin for a current MCS and Nss.

19. The non-transitory computer readable memory medium of claim 16,
wherein the fast feedback information includes a per stream effective signal to interference plus noise ratio (SINR) or SINR margin for a reference modulation and coding scheme (MCS) and number of spatial streams (Nss);
wherein the effective SINR margin is based, at least in part, on a modulation level applied on each stream;
wherein the reference MCS is indicated as a delta MCS or a delta anchor MCS; and
wherein the reference MCS is a one level increase or one level decrease from a current MCS level.

20. The non-transitory computer readable memory medium of claim 16,
wherein the fast feedback information includes one or more of an interference pattern or a probing recommendation and at least one bit indicating whether to directly use the fast feedback information for link adaptation or to use the fast feedback as a probing recommendation; and
wherein the interference pattern indicates whether interference is relatively stable across a plurality of received PPDUs, frequently varying across the plurality of received PPDUs, or short, bursty interference.
